(19) United States
(12) Patent Application Publication
(10) Pub. No.: US 2006/0146356 A1
(43) Pub. Date: Jul. 6, 2006

(54) Method of starting to produce print data simultaneously with starting to spool a meta file

(76) Inventor: Seung-sik Yang, Yongin-si (KR)

Correspondence Address: STANZIONE & KIM, LLP, 919 18TH STREET, N.W., SUITE 440, WASHINGTON, DC, 20006, US

(21) Appl. No.: 11/320,787

(22) Filed: Dec. 30, 2005

(30) Foreign Application Priority Data
Jan. 4, 2005 (KR) 2005-453

(51) Int. Cl. G06F 3/12

(52) U.S. Cl. 358/1.13; 358/1.15

(57) ABSTRACT

A method of producing a print data including generating a meta file for a printing-requested image and spooling the generated meta file, starting to produce print data for the spooled meta file within a predetermined time from a starting time of spooling the meta file, and spooling the generated print data. The starting time of generating the print data is immediate so that the starting time and the completing time of printing the image for the print data is short. Therefore, the required time for printing is short.

### CROSS-REFERENCE TO RELATED APPLICATIONS

This application claims the benefit of Korean Patent Application No. 2005-000453 filed on Jan. 4, 2005, in the Korean Intellectual Property Office, the disclosure of which is incorporated herein in its entirety.

### BACKGROUND OF THE INVENTION

1. Field of the Invention

The present general inventive concept relates to a method of producing print data. More particularly, the present general inventive concept relates to a method of producing print data simultaneously with starting to spool a meta file.

2. Description of the Related Art

Print data is formed to be decoded by a printing device, and refers to data regarding a content of an image to be printed by the printing device. Generally, a meta file for an image is generated, and print data starts to be produced for the meta file in order to produce print data for an image.

The process of producing print data for an image is explained in detail below.

A user may input a printing request for a desired image via an application installed in a computer. An operating system installed in the computer starts to produce a meta file for the requested image and spools the meta file.

As the meta file is spooled by a predetermined amount (generally 500 k bytes), the operating system calls for a printer driver installed in the computer. The called printer driver starts to produce print data for the spooled meta file. The generated print data is then spooled. The spooled print data is transmitted to an external printing device, and the external printing device prints the image corresponding to the received print data.

To print the image, it is desired to shorten the required time for printing, which is a time from the printing request to the printing completion.

One of the detailed operations of forming the image printing process is to generate the print data for the image. It is very important to implement the starting time to produce the print data as soon as possible to avoid delays in the print result. If the starting time to produce the print data is quick, the starting time to print an image corresponding to the print data is also quick so that the printing completion time can also be quick and the required time for printing can be shortened.

Accordingly, it is required to implement the starting time to generate the print data as quick as possible.

### SUMMARY OF THE INVENTION

The present general inventive concept provides a method of generating print data which starts to produce the print data simultaneously with starting to spool a meta file so that a starting time to generate the print data is implemented in a short amount of time.

Additional aspects and advantages of the present general inventive concept will be set forth in part in the description which follows and, in part, will be obvious from the description, or may be learned by practice of the general inventive concept.

The foregoing and/or other aspects and utilities may be achieved by providing a method of producing print data, the method includes , generating a meta file for a printing-requested image and spooling the generated meta file, starting to produce print data for the spooled meta file within a predetermined amount of time from a starting time of spooling the meta file, and spooling the generated print data.

In the operation of starting to produce print data, a printing device driver may be called on within a predetermined amount of time from the starting time of spooling the meta file so as to start to produce the print data for the spooled meta file.

In the operation of starting to produce print data, the print data may start to be produced for the spooled meta file in two seconds from the starting time of spooling the meta file.

The method according to the present embodiment may further include starting to transmit the spooled print data to the external printing device within a predetermined time from the starting time of spooling the print data.

A recording medium readable by a computer and recording a program to execute a procedure may include generating a meta file for a printing-requested image and spooling the generated meta file, starting to produce a print data for the spooled meta file within a predetermined amount of time from a starting time of spooling the meta file, and spooling the produced print data.

The printing device driver may be called on within a predetermined amount of time from the starting time of spooling the meta file so that the print data for the spooled meta file starts to be produced in the operation of starting to produce print data.

In the operation of starting to produce print data, the print data starts to be produced for the spooled meta file within two seconds from the starting time of spooling the meta file.

The program recorded at a recording medium readable by the present computer may execute a procedure further including starting to transmit the spooled print data to an external printing device within a predetermined amount of time from a starting time of spooling the print data.

The foregoing and/or other aspects and utilities may be achieved by providing a method of producing print data comprising generating a meta file for a printing-requested image and spooling the generated meta file; and producing print data for the spooled meta file simultaneously with a starting time of spooling the meta file.

The foregoing and/or other aspects and utilities may be achieved by providing method of producing a print data comprising producing and spooling a first meta file for an input request for a first generated and edited image; and producing and editing a second image while simultaneously producing and spooling the first meta file

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 illustrates a program architecture to which the present general inventive concept can be applied; and

FIG. 2 is a flowchart illustrating a method of starting to produce the print data simultaneously with starting to spool a meta file, according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

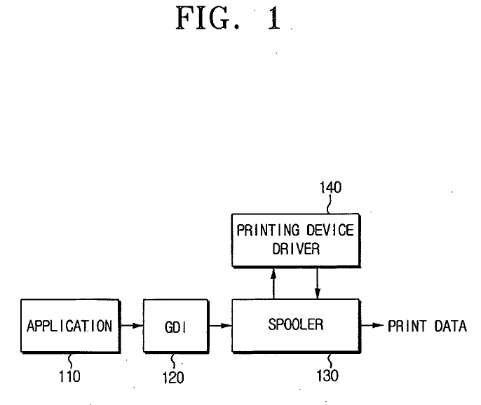

FIG. 1 illustrates a program architecture to which a method of starting to produce print data simultaneously with starting to spool a meta file according to an embodiment of the present general inventive concept can be applied. The program architecture of FIG. 1 illustratesassociative relations among the illustrated programs 110 to 140.

The illustrated programs 110 to 140 are installed in a device which can execute programs. An example of the device which can execute programs includes a computer. A central processing device of the computer selectively or compositely executes programs installed in the computer such that a user can perform printing for the requested image.

A Graphic Device Interface (GDI) 120 and a spooler 130 among the programs are generally included in the operating system. An application 110 and a printing device driver 140 are selectively installed according to a user's need.

The application 110 is a program in which a user can generate and edit ‘text, picture’ (hereinafter image) to be printed and input a printing request for the completely generated and edited image.

Examples of the application 110 include a word processing program, a data base program, an image editing program, and a browser. Any program may be applied to the application 110 if a printing request for an image can be input.

The GDI 120 is a program to transmit an image to be displayed or printed to an external device such as a display or a printing device.

The GDI 120 produces a meta file for the printing-requested image. The meta file may be understood as an intermediate product while producing the print data for an image. This is because the meta file for the image is produced first, and then the print data for the meta file is generated to produce the print data for the image. A detailed description of the print data will be described hereinafter. An enhanced meta file may be applied to the meta file.

The printing device driver 140 is a program to drive the printing device. In more detail, the printing device driver 140 produces the print data for the meta file. The print data is formed to be decoded by the printing device, and represents data regarding a content of an image to be printed.

The spooler 130 is a program to spool onto a recording medium of the computer the meta file generated by the GDI 120 and the print data generated by the printing device driver 140. Examples of the recording medium include, for example, a Random Access Memory (RAM) and a Hard Disk Drive (HDD). However, other recording mediums may be used as an alternative.

The spooler 130 also sequentially transmits the spooled print data to the printing device.

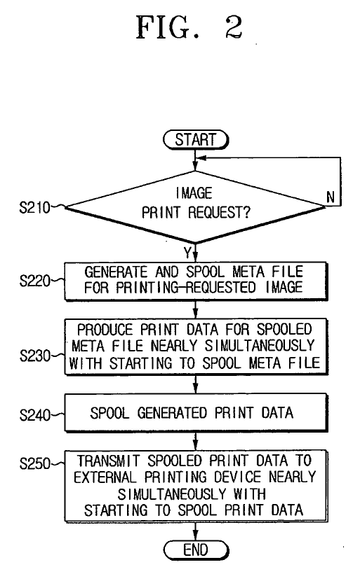

Hereinafter, a method to immediately start to produce the print data for a printing-requested image so that the printing starting time of the printing device can be performed quickly by using the program architecture of FIG. 1, will be described in detail with reference to FIG. 2.

Additionally, the method will be explained hereinafter for quickly starting to transmit the generated print data to the printing device so that the printing starting time of the printing device can be performed quickly.

FIG. 2 is a flowchart of a method of starting to produce print data simultaneously with starting to spool a meta file according to an embodiment of the present general inventive concept.

First, if a user inputs a printing request for a completely generated and edited image using the application 110 (operation S210), the GDI 120 produces a meta file for the printing-requested image, and the spooler 130 spools the meta file being produced (operation S220).

As the producing of and spooling of the meta file are being completed, a user can generate and edit another image using the application 110. In other words, a Return to Application (RTA) is made.

The meta file for the printing-requested image is produced very quickly. Furthermore, it takes relatively little time for the RTA, and therefore, a user can re-use the application 110 in a relatively short period of time.

The print data for the spooling meta file starts to be produced simultaneously with starting to spool the meta file of the operation S220 (operation S230). Stated differently, the print data for the spooled meta file starts to be produced within a predetermined period of time from the starting time of spooling of the meta file in the operation S230.

The print data can start to be produced within ‘two seconds’ from the starting time of spooling of the meta file, or can start to be produced simultaneously with starting to spool the meta file. In contrast, print data for a spooled meta file conventionally starts to be produced longer than two seconds after the starting time of spooling of the meta file.

The printing device driver 140 is called on within a predetermined period of time from the starting time of spooling of the meta file and allows the printing device driver 140 to start to produce the print data for the spooled meta file immediately, such that the operation S230 of FIG. 2 can be realized.

In the present embodiment, the print data for the meta file starts to be produced simultaneously with starting to spool the meta file.

Accordingly, the starting time of generating the print data is very quick at the printing device driver 140. Accordingly, the starting time of generating the print data is very quick, the starting time of printing the image for the print data is very quick, and the completion time of printing is also very quick, as a result.

In contrast with the above embodiment, the conventional art takes at least two seconds to spool the meta file having a length of 500 KB. As such, the starting time and completing time of printing in the embodiment of the present general inventive concept is quicker (by at least two seconds). As a result, when it takes a small amount of required time for printing an image, which takes an amount of time from the printing request to the printing completion, that is, if the amount of the image to be printed is small, a user can experience the time difference significantly as compared to the conventional method. In other words, assuming that the required time for printing is 10 seconds according to conventional art, the required time for printing is reduced to 8 seconds or less according to the present embodiment. Although the required time for printing is reduced by 20%, it is sufficient for a user to experience the time reduction significantly.

Then, the spooler 130 spools the print data generated from the operation S230 (operation S240). The spooler 130 starts to transmit the spooled print data to an external printing device nearly simultaneously with starting to spool the print data (operation S250). In more detail, the spooled print data starts to be transmitted to the external printing device within a predetermined time from the starting time of spooling the print data such that the operation S250 can be realized. Moreover, the spooled print data can start to be transmitted to the external printing device simultaneously with starting to spool the print data.

In the present embodiment, the print data starts to be transmitted to the external printing device nearly simultaneously with starting to spool the print data. Accordingly, the starting time of printing is very quick, and therefore, the completing time of printing is very quick.

As described above, when the embodiments of the present general inventive concept are applied, the print data starts to be produced for the meta file simultaneously with starting to spool the meta file so that the starting time of producing the print data is very quick. Accordingly, if the starting time of generating the print data is simultaneous with starting to spool the meta file, the starting time of printing the image for the print data is very quick, and therefore, the completing time of printing is very quick with respect to a request to print an image, and the required time for printing is reduced.

Additionally, the print data starts to be transmitted to the printing device simultaneously with starting to spool the print data so that the printing start time of the printing device is very quick and the printing completion time is also very quick. Therefore, the required time for printing according to the embodiments of the present general inventive concept is decreased.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of producing a print data comprising:
generating a meta file for a printing-requested image and spooling the generated meta file;
starting to produce print data for the spooled meta file within a predetermined time from a starting time of spooling the meta file; and
spooling the generated print data.

2. The method as claimed in claim 1, wherein, in the operation of starting to produce print data, a printing device driver is called on within a predetermined amount of time from the starting time of spooling the meta file so as to start to produce the print data for the spooled meta file.

3. The method as claimed in claim 1, wherein, in the operation of starting to produce print data, the print data starts to be produced for the spooled meta file within two seconds from the starting time of spooling the meta file.

4. The method as claimed in claim 1, further comprising:
starting to transmit the spooled print data to the external printing device within a predetermined amount of time from the starting time of spooling the print data.

5. A recording medium readable by a computer and capable of recording a program to execute a procedure, the procedure comprising:
generating a meta file for a printing-requested image and spooling the generated meta file;
starting to produce print data for the spooled meta file within a predetermined time from a starting time of spooling the meta file; and
spooling the produced print data.

6. The recording medium as claimed in claim 5, wherein a printing device driver is called on within a predetermined period of time from the starting time of spooling the meta file so that the print data for the spooled meta file starts to be produced in the operation of starting to produce the print data.

7. The recording medium as claimed in claim 5, wherein, in the step of b), the print data starts to be produced for the spooled meta file within two seconds from the starting time of spooling the meta file.

8. The recording medium as claimed in claim 5, further comprising:
starting to transmit the spooled print data to an external printing device within a predetermined time from a starting time of spooling the print data.

9. A method of producing print data comprising:
generating a meta file for a printing-requested image and spooling the generated meta file; and
producing print data for the spooled meta file simultaneously with a starting time of spooling the meta file.

10. The method as claimed in claim 9, wherein the producing of the print data includes requesting a printing driver device within a predetermined amount of time from the starting time of spooling the meta file to start the generating of the print data.

11. The method as claimed in claim 9, further comprising:
spooling the generated print data; and
starting to transmit the spooled print data to the external printing device within a predetermined time from the starting time of spooling the print data.

12. A method of producing a print data comprising:
producing and spooling a first meta file for an input request for a first generated and edited image; and
producing and editing a second image while simultaneously producing and spooling the first meta file.
